(19) United States
(12) Patent Application Publication
(10) Pub. No.: US 2026/0332494 A1
(43) Pub. Date: Oct. 22, 2026

(54) ABNORMALITY DETECTION DEVICE, ABNORMALITY DETECTION METHOD AND ABNORMALITY DETECTION PROGRAM

(71) Applicant: NTT. Inc., Tokyo (JP)

(72) Inventors: Shohei ISHIMURA, Musashino-shi, Tokyo (JP); Atsushi SUTO, Musashino-shi, Tokyo (JP); Yuhei HAYASHI, Musashino-shi, Tokyo (JP)

(21) Appl. No.: 19/122,424

(22) PCT Filed: Dec. 22, 2022
(86) PCT No.: PCT/JP2022/047455

§ 371 Date: Apr. 18, 2025

(51) Int. Cl. H04L 43/062; H04L 43/04; H04L 43/16

(52) U.S. Cl. CPC H04L 43/062; H04L 43/04; H04L 43/16

(57) ABSTRACT

In an abnormality detection device, an acquisition unit acquires past traffic data and stores the past traffic data in a buffer region of a storage unit. A calculation unit calculates an average and a variance of the traffic data in the buffer region by applying the traffic data to a predetermined recurrence formula. An analysis unit calculates a Z score representing a deviation from an average of traffic data as a processing target by using the average and the variance that have been calculated, and analyzes whether the traffic data is abnormal by using the Z score.

### TECHNICAL FIELD

The present invention relates to an abnormality detection device, an abnormality detection method, and an abnormality detection program.

### BACKGROUND ART

In order for a user to stably use a service such as a so-called over-the-top (OTT) service provided through a network, it is essential for a network operator to detect an abnormality of traffic in the network and cope with the cause.

There is known a conventional traffic abnormality detection technology in which daily traffic data is classified into patterns using clustering or the like and stored, a similar pattern is selected from newly input data, and an abnormality is determined when a difference from the pattern is large (see Patent Literature 1).

### CITATION LIST

### Patent Literature

Patent Literature 1: JP 2017-143399 A

### SUMMARY OF INVENTION

### Technical Problem

However, according to the conventional technology, the cost for abnormality detection may be large. For example, the more traffic data for each stored pattern, the more data accesses and calculations for comparison occur, and thus there is a problem that cost is required temporally and computationally.

The present invention has been made in view of the above, and an object of the present invention is to perform traffic abnormality detection while suppressing cost.

### Solution to Problem

In order to solve the above problem and achieve the object, an abnormality detection device according to the present invention includes: an acquisition unit that acquires past traffic data and stores the past traffic data in a buffer region of a storage unit; a calculation unit that calculates an average and a variance of traffic data in the buffer region by applying the traffic data to a predetermined recurrence formula; and an analysis unit that calculates a Z score representing a deviation from an average of traffic data as a processing target by using the average and the variance that have been calculated, and analyzes whether the traffic data is abnormal by using the Z score.

### Advantageous Effects of Invention

According to the present invention, it is possible to detect traffic abnormality while suppressing cost.

### BRIEF DESCRIPTION OF DRAWINGS

FIG. 1 is a diagram for explaining an outline of an abnormality detection device according to the present embodiment.

FIG. 2 is a diagram for explaining an outline of the abnormality detection device according to the present embodiment.

FIG. 3 is a diagram for explaining an outline of the abnormality detection device according to the present embodiment.

FIG. 4 is a diagram for explaining an outline of the abnormality detection device according to the present embodiment.

FIG. 5 is a schematic diagram illustrating a schematic configuration of the abnormality detection device according to the present embodiment.

FIG. 6 is a diagram for describing processing of a calculation unit.

FIG. 7 is a flowchart illustrating an abnormality detection processing procedure.

FIG. 8 is a diagram illustrating an example of a computer that executes an abnormality detection program.

### DESCRIPTION OF EMBODIMENTS

Hereinafter, an embodiment of the present invention will be described in detail with reference to the drawings. Note that the present invention is not limited by the embodiment. Furthermore, in the description of the drawings, the same portions are denoted by the same reference numerals.

### [Outline of Abnormality Detection Device]

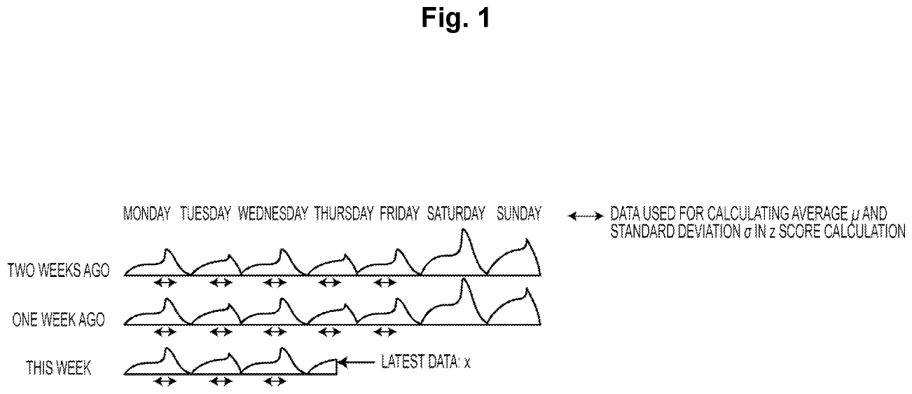

FIGS. 1 to 4 are diagrams for explaining an outline of an abnormality detection device according to the present embodiment. The abnormality detection device according to the present embodiment compares a value of traffic data to be analyzed as to whether it is abnormal with a traffic data group in past normal times, and determines that the data is abnormal when a deviation from an average of the traffic data group is larger than a predetermined threshold Th. Specifically, the abnormality detection device calculates a Z score z representing a degree of deviation from the average of the latest traffic data x as in Expression (1) as below by using an average μ and a standard deviation σ in a range indicated by a double-headed arrow in FIG. 1 as a statistic of the traffic data group in the past normal times.

$$\begin{matrix}[ Math . 1 ] & \\ z = \frac{x - μ}{σ} ( = Normalize by average and variance ) & ( 1 )\end{matrix}$$

In the example illustrated in FIG. 1, data in the same time zone is selected only for past weekdays as a comparison target of the latest data x of Thursday. In this manner, the user can set as desired the comparison target day of the week by using a predetermined setting file.

Then, the abnormality detection device uses the calculated Z score z as an index for analysis of whether the traffic data x is abnormal. That is, the abnormality detection device considers that, as the absolute value of the Z score is larger, the abnormal value is a value more deviating from the average, and detects the abnormality of the traffic data x when z normalized by the average and the variance as shown in Expression (1) described above is larger than a predetermined threshold Th. Since the standard deviation σ is defined by the square root v of the variance V, the Z score is expressed using the variance V below.

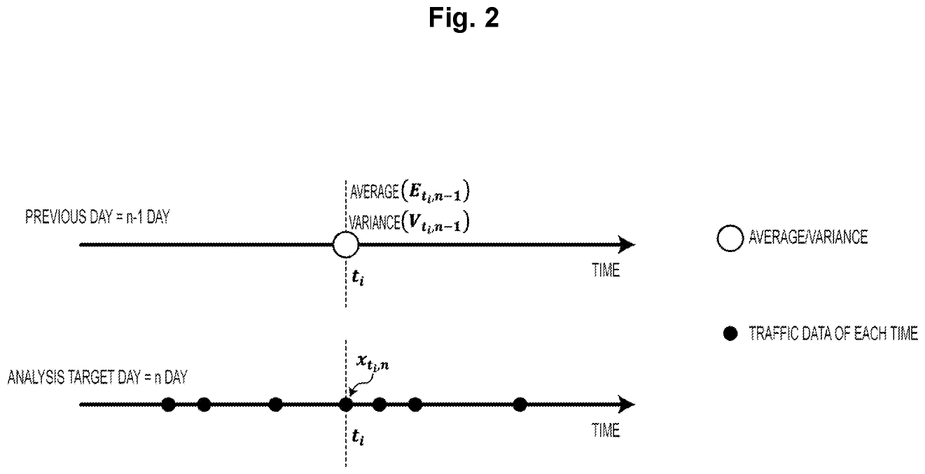

As described above, the Z score of the traffic data to be analyzed is represented by the average and variance of the traffic data in the past normal times. For example, as illustrated in FIG. 2, a Z score z_{ti,n} of traffic data x_{ti,n} (“ₜᵢ” is the subscript for “tᵢ”) at time tᵢ of a day n on which the analysis is performed is expressed by Expression (2) below by using an average E_{ti,n-1} and a variance V_{ti,n-1} at the same time tᵢ of the previous day n−1. The previous day in this case is not necessarily the previous day on the date.

[Math. 2]

zₜ_{ᵢ}_{,n}=(xₜ_{ᵢ}_{,n}−Eₜ_{ᵢ}_{,n-1})/\sqrt{Vₜ_{ᵢ}_{,n-1}} (2)

When the Z score z_{ti,n} obtained here is larger than the predetermined threshold Th, abnormality of the traffic data x_{ti,n} at the time tᵢ can be detected.

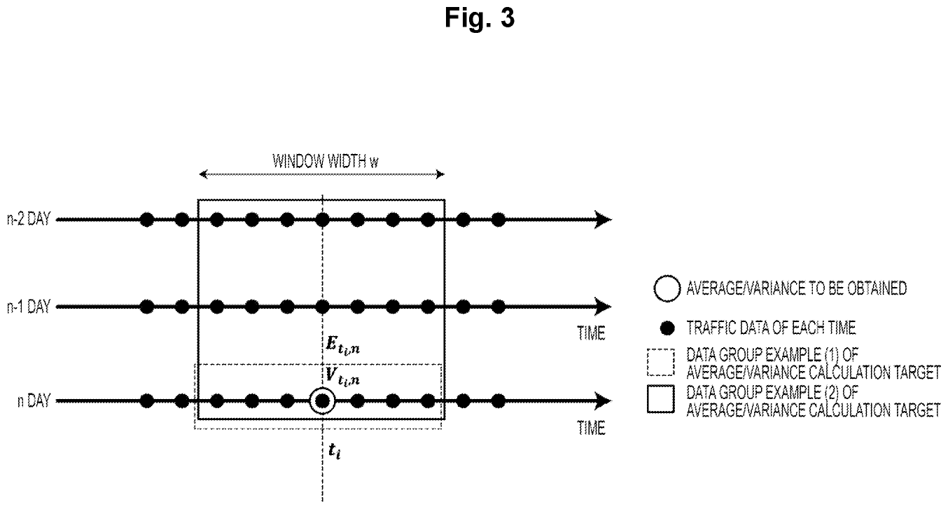

Here, as illustrated in FIG. 3, in order to calculate the Z score at the time tᵢ of the next day n+1, the abnormality detection device obtains the average E_{ti,n} and the variance V_{ti,n} of the traffic data group of a certain day n at the time tᵢ. Here, the average and the variance, which are basic statistics of the data group, are obtained from a certain number of data groups, and the larger the number, the higher the generality and probability of the statistics. In the example illustrated in FIG. 3, it is considered to be more preferable to obtain the average and the variance from a data group having a larger number of pieces of data including further past pieces of data as in the range of (2) surrounded by a solid line than to obtain the average and the variance from a data group in the range of (1) surrounded by a broken line because the generality and probability of the obtained average and variance are high. On the other hand, when the average and the variance are obtained from the data group in the range (2) surrounded by the solid line rather than the data group in the range (1) surrounded by the broken line, the number of times of access to the storage unit holding the past traffic data and the number of times of calculation increase, and thus the cost increases.

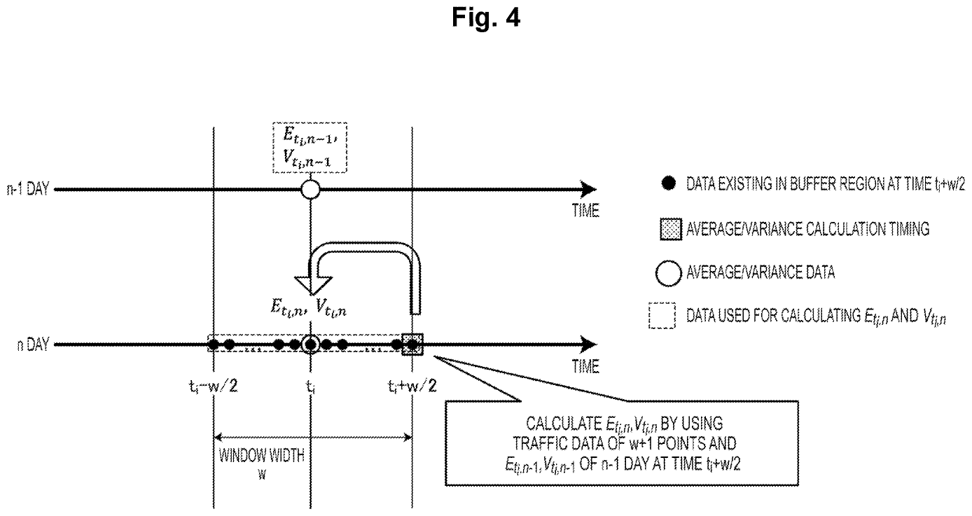

Therefore, the abnormality detection device holds traffic data of at least w+1 points corresponding to a window width w in the past direction from the current time (calculation timings of the average and the variance) in a buffer region such as a main memory that can be accessed at high speed. In this case, as illustrated in FIG. 4, at time tᵢ+w/2, traffic data of w+1 point corresponding to the window width w from time tᵢ-w/2 to time tᵢ+w/2 is held in the buffer region. As a result, the abnormality detection device can acquire the data of the current day n only by accessing the buffer region at a high speed without accessing the storage unit at the time tᵢ+w/2.

When calculating the average E_{ti,n} and the variance V_{ti,n} at the time tᵢ on the current day n, the abnormality detection device utilizes the calculated average E_{ti,n-1} and variance V_{ti,n-1} at the time tᵢ on the previous day n−1. Then, the abnormality detection device stores the calculated average E_{ti,n} and variance V_{ti,n} in the storage unit.

As described above, when calculating the average E_{ti,n} and the variance V_{ti,n} at the time tᵢ on a certain day n, the abnormality detection device can acquire at least traffic data of the current day n from the buffer region without accessing the storage unit. As a result, the abnormality detection device can efficiently calculate the average E_{ti,n} and the variance V_{ti,n} by acquiring a part of the past traffic data at a higher speed than acquiring all of the past traffic data from the storage unit.

The abnormality detection device calculates the average E_{ti,n} and the variance V_{ti,n} by utilizing the average E_{ti,n-1} and the variance V_{ti,n-1} of the previous day n−1, so that it is possible to calculate a more general and probable average and variance. Therefore, the abnormality detection device can perform abnormality detection using the Z score of the traffic data with high efficiency and high accuracy.

### [Configuration of Abnormality Detection Device]

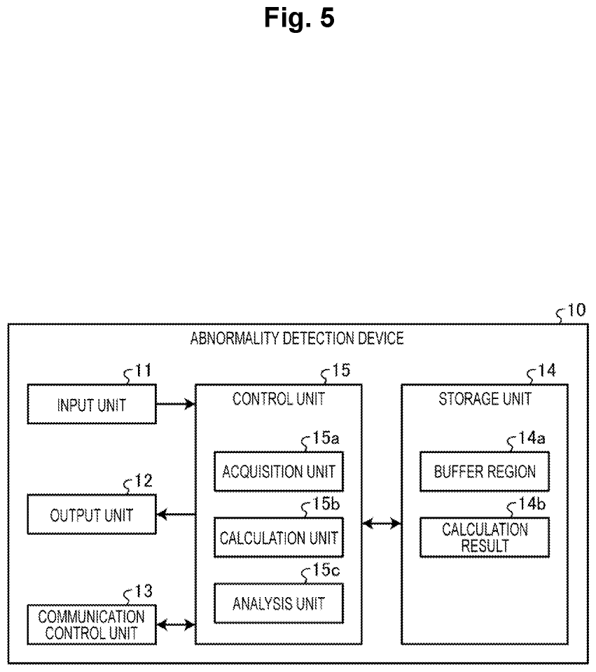

FIG. 5 is a schematic diagram illustrating a schematic configuration of the abnormality detection device according to the present embodiment. As illustrated in FIG. 5, an abnormality detection device 10 of the present embodiment is implemented with a general-purpose computer such as a personal computer, and includes an input unit 11, an output unit 12, a communication control unit 13, a storage unit 14, and a control unit 15.

The input unit 11 is implemented using an input device such as a keyboard or a mouse, and inputs various types of instruction information, such as an instruction to cause the control unit 15 to start processing, in response to an input operation of an operator. The output unit 12 is implemented with a display device such as a liquid crystal display, a printing device such as a printer, or the like. For example, the output unit 12 displays a result of abnormality detection processing that will be described later.

The communication control unit 13 is implemented by a network interface card (NIC) or the like, and controls communication between the control unit 15 and an external device via a telecommunication line such as a local area network (LAN) or the Internet. For example, the communication control unit 13 controls communication between the control unit 15 and a management device or the like that manages various types of information.

The storage unit 14 is implemented by a semiconductor memory element such as random access memory (RAM) or flash memory, or a storage device such as a hard disk or an optical disc. In the storage unit 14, a processing program for operating the abnormality detection device 10, data to be used during execution of the processing program, and the like are stored in advance, or temporarily stored each time the processing is performed. Note that the storage unit 14 may be configured to communicate with the control unit 15 via the communication control unit 13. In the present embodiment, the storage unit 14 includes a buffer region 14a. The storage unit 14 stores a calculation result 14b of the average, variance, Z score, and the like in abnormality detection processing described later.

The control unit 15 is implemented by a central processing unit (CPU) or the like, and executes a processing program stored in a memory. As a result, as illustrated in FIG. 5, the control unit 15 functions as an acquisition unit 15a, a calculation unit 15b, and an analysis unit 15c, and executes abnormality detection processing. Note that each or some of these functional units may be implemented in different sets of hardware. For example, the analysis unit 15c may be implemented in a device different from other functional units. In addition, the control unit 15 may also include other functional units.

The acquisition unit 15a acquires past traffic data and stores the past traffic data in the buffer region 14a of the storage unit 14. For example, the acquisition unit 15a acquires traffic data from a management device or the like that manages past traffic data collected from the network via the input unit 11 or the communication control unit 13. Then, the acquisition unit 15a stores the acquired traffic data in the buffer region 14a. Specifically, the acquisition unit 15a stores traffic data of w+1 points corresponding to a predetermined window width w from time tᵢ-w/2 to time tᵢ+w/2 of n day illustrated in FIG. 4 in the buffer region 14a. The window width w can be set as desired by the user.

The calculation unit 15b applies the traffic data in the buffer region 14a to a predetermined recurrence formula to calculate an average and a variance of the traffic data.

The calculation unit 15b stores the calculated average and variance in the calculation result 14b of the storage unit 14. In this case, the calculation unit 15b may store the calculation result 14b in a region other than the buffer region 14a.

When calculating the average and the variance of the traffic data acquired next, the calculation unit 15b uses the average and the variance of the previous day of the calculation result 14b further calculated.

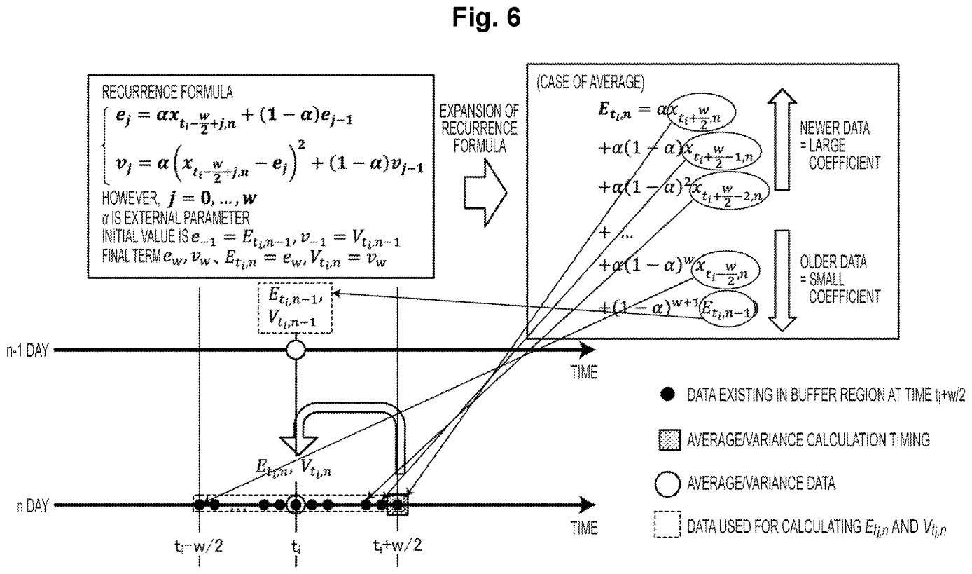

Here, FIG. 6 is a diagram for describing processing of the calculation unit. Specifically, as illustrated in FIG. 6, the calculation unit 15b applies the acquired traffic data stored in the buffer region 14a, and the average E_{ti,n-1} and the variance V_{ti,n-1} of the previous day n−1 of the calculation result 14b to the recurrence formula of Expression (3) below. As described above, the calculation unit 15b obtains the average E_{ti,n} and the variance V_{ti,n} in an exponential smoothing average manner.

$$\begin{matrix}[ Math . 3 ] & \\ \begin{matrix}{e}_{j} = α {x}_{{t}_{i} - \frac{w}{2} + j , n} + ( 1 - α ) {e}_{j - 1} \\ {v}_{j} = α {( {x}_{{t}_{i} - \frac{w}{2} + j , n} - {e}_{j} )}^{2} + ( 1 - α ) {v}_{j - 1}\end{matrix} \} & ( 3 )\end{matrix}$$

Where α is external setting parameter.
j=0, . . . w (w is positive even number)

In Expression (3) described above, an average calculation process eⱼ is used for the variance calculation process vⱼ. The initial value e₋₁=E_{ti,n-1}, v₋₁=V_{ti,n-1} is satisfied. In addition, using the final terms e_{w} and v_{w}, E_{ti,n}=e_{w}, V_{ti,n}=v_{w} is satisfied. Here, the average and variance (≠0) of the previous day on the first day when the traffic data starts to be collected can be set as desired by the user, and for example, average=0 and variance=1 are satisfied.

The recurrence formula of Expression (3) described above is expressed by Expression (4) below when developed for the average E_{ti,n} at the time tᵢ, for example.

$$\begin{matrix}[ Math . 4 ] & \\ {E}_{{t}_{i} , n} = {α x}_{{t}_{i} + \frac{w}{2} , n} + α ( 1 - α ) {x}_{{t}_{i} + \frac{w}{2} - 1 , n} + {α ( 1 - α )}^{2} {x}_{{t}_{i} + \frac{w}{2} - 2 , n} + … + {α ( 1 - α )}^{w} {x}_{{t}_{i} - \frac{w}{2} , n} + {( 1 - α )}^{w + 1} {E}_{{t}_{i} , n - 1} ) & ( 4 )\end{matrix}$$

Here, the parameter a is any predetermined value in the range of 0<α<1, and the larger the value of α, the smaller the contribution degree to the calculation result of the past traffic data. As illustrated in FIG. 6, as the traffic data is further past data, the coefficient including the parameter a in Expression (4) described above is smaller and the contribution degree to the calculation result is smaller.

As described above, the calculation unit 15b applies the past traffic data to the weighted recurrence formula such that the contribution degree of the traffic data is smaller as the traffic data is further past data. This makes it possible to efficiently and quickly calculate an average and a variance by using a small number of pieces of past wide range traffic data.

The description returns to FIG. 5. The analysis unit 15c calculates a Z score representing a deviation from the average of the traffic data as the processing target using the calculated average and variance, and analyzes whether the traffic data is abnormal by using the Z score. Specifically, the analysis unit 15c determines that the traffic data as the processing target is abnormal when the calculated Z score is larger than a predetermined threshold Th.

As described above, the abnormality detection device 10 efficiently calculates the Z score by using the average and variance that are highly general and probable, and thus, can detect an abnormality by using the Z score of the traffic data with high accuracy.

### [Abnormality Detection Processing]

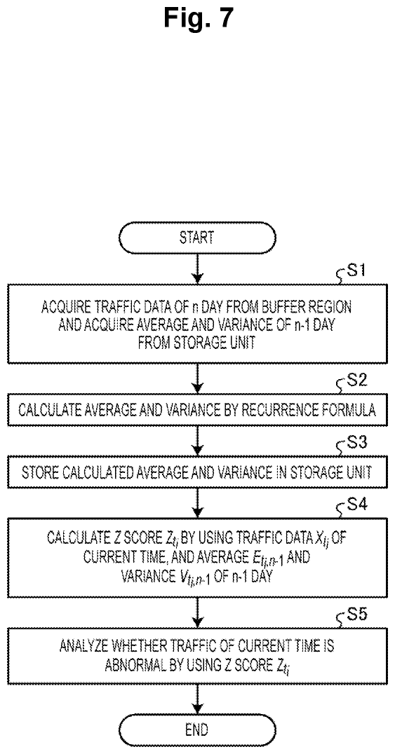

Next, abnormality detection processing by the abnormality detection device 10 according to the present embodiment will be described with reference to FIG. 7. FIG. 7 is a flowchart illustrating an abnormality detection processing procedure. The flowchart of FIG. 7 is started at, for example, a timing when the user performs an operation input to instruct a start with a time tᵢ on a certain day n as a current time.

First, the calculation unit 15b acquires w+1 pieces of traffic data up to the current time from the buffer region 14a. In addition, the calculation unit 15b acquires the average E_{ti,n-1} and the variance V_{ti,n-1} at the time tᵢ on the previous day n−1 of the calculation result 14b of the storage unit 14 for Z score calculation. The calculation unit 15b acquires the average E_{ti-w/2,n-1} and the variance V_{ti-w/2,n-1} at the time tᵢ-w/2 of the previous day n−1 of the calculation result 14b of the storage unit 14 for the calculation of the average and the variance for n day (step S1).

Then, the calculation unit 15b applies the acquired w+1 pieces of traffic data in the buffer region, E_{ti-w/2,n-1}, and the variance V_{ti-w/2,n-1} to a predetermined recurrence formula to calculate the average E_{ti-w/2,n} and the variance V_{ti-w/2,n} (step S2). In addition, the calculation unit 15b stores the calculated average E_{ti-w/2,n} and variance V_{ti-w/2,n} in the calculation result 14b of the storage unit 14 (step S3). The average E_{ti-w/2,n} and the variance V_{ti-w/2,n} calculated here are used for abnormality detection at time tᵢ-w/2 of n+1 day.

In addition, the analysis unit 15c calculates the Z score zₜᵢ using the traffic data xₜᵢ at the current time, the calculated average E_{ti,n-1} and variance V_{ti,n-1} of n−1 day (step S4). Then, the analysis unit 15c analyzes whether the traffic data at the current time is abnormal using the Z score zₜᵢ (step S5). Specifically, the analysis unit 15c determines that the traffic data as the processing target is abnormal when the calculated Z score zₜᵢ is larger than a predetermined threshold Th. Thereby, a series of abnormality detection processing ends.

### [Effects]

As described above, in the abnormality detection device 10 of the present embodiment, the acquisition unit 15a acquires the past traffic data and stores the acquired data in the buffer region 14a of the storage unit 14. The calculation unit 15b applies the traffic data in the buffer region 14a to a predetermined recurrence formula to calculate an average and a variance of the traffic data, and stores the calculated average and variance in the storage unit 14. The analysis unit 15c calculates a Z score representing a deviation from the average of the traffic data as the processing target using the average and variance of the same time of the previous day calculated on the previous day, and analyzes whether the traffic data is abnormal by using the Z score.

Specifically, the analysis unit 15c determines that the traffic data as the processing target is abnormal when the calculated Z score is larger than a predetermined threshold.

As described above, when calculating the average E_{ti,n} and the variance V_{ti,n} at the time tᵢ on a certain day n, the abnormality detection device 10 can acquire at least traffic data of the current day n from the buffer region without accessing the storage unit. As a result, the abnormality detection device 10 can efficiently calculate the average E_{ti,n} and the variance V_{ti,n} by acquiring the past traffic data at a higher speed than acquiring all of the past traffic data from the storage unit. Therefore, the abnormality detection device 10 can efficiently perform the abnormality detection using the Z score of the traffic data while suppressing the temporal and calculation quantitative cost.

When calculating the average and the variance of the traffic data acquired next, the calculation unit 15b further uses the average and the variance of the previous day further calculated. Specifically, every time there is newly acquired traffic data, the calculation unit 15b calculates the average E_{ti-w/2,n} and the variance V_{ti-w/2,n} at a time earlier by w/2 from the time, using the average and the variance at the same time on the previous day. As described above, the abnormality detection device 10 calculates the today's average and variance used when calculating the Z score of the next day by utilizing the average and variance of the previous day n−1, thereby being able to calculate more general and probable average and variance. Therefore, the abnormality detection device 10 can perform abnormality detection using the Z score of the traffic data with high accuracy.

In addition, the calculation unit 15b applies the past traffic data to the weighted recurrence formula such that the contribution degree of the traffic data is smaller as the traffic data is further past data. This makes it possible to efficiently calculate an average and a variance by using a small amount of past wide range traffic data.

### [Program]

It is also possible to create a program in which the processing executed by the abnormality detection device 10 according to the above embodiment is described in a language executable by a computer. As an embodiment, the abnormality detection device 10 can be implemented by installing an abnormality detection program for executing the above-described abnormality detection processing as package software or online software in a desired computer. For example, by causing an information processing device to execute the abnormality detection program described above, the information processing device can be caused to function as the abnormality detection device 10. The information processing device described here includes a general computer such as a computer for a server and a desktop personal computer or a laptop personal computer. In addition, the category of the information processing device includes a mobile communication terminal such as a smartphone, a mobile phone, or a personal handyphone system (PHS), a slate terminal such as a personal digital assistant (PDA), and the like. Further, the functions of the abnormality detection device 10 may be implemented in a cloud server.

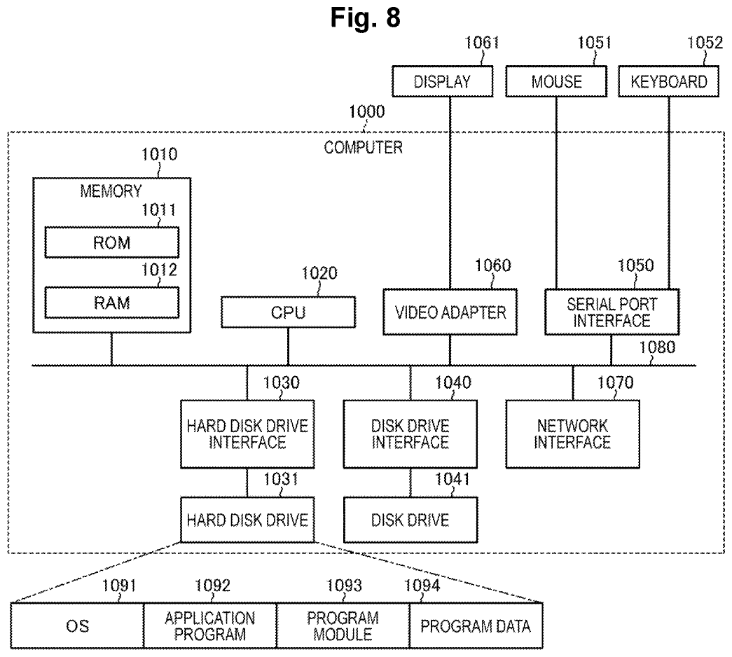

FIG. 8 is a diagram illustrating an example of a computer that executes an abnormality detection program. A computer 1000 includes, for example, a memory 1010, a CPU 1020, a hard disk drive interface 1030, a disk drive interface 1040, a serial port interface 1050, a video adapter 1060, and a network interface 1070. These components are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disk is inserted into the disk drive 1041. The serial port interface 1050 is connected to, for example, a mouse 1051 and a keyboard 1052. The video adapter 1060 is connected to, for example, a display 1061.

The hard disk drive 1031 stores, for example, an operating system (OS) 1091, an application program 1092, a program module 1093, and program data 1094. All pieces of the information described in the embodiment are stored, for example, in the hard disk drive 1031 or the memory 1010.

The abnormality detection program is stored in the hard disk drive 1031 as a program module 1093 in which a command executed by the computer 1000 is described, for example. Specifically, the program module 1093 in which each processing executed by the abnormality detection device 10 described in the above embodiment is described is stored in the hard disk drive 1031.

In addition, data used for information processing performed by the abnormality detection program is stored, for example, in the hard disk drive 1031 as the program data 1094. Then, the CPU 1020 reads, into the RAM 1012, the program module 1093 and the program data 1094 stored in the hard disk drive 1031 as necessary and executes each procedure described above.

Note that the program module 1093 and the program data 1094 related to the abnormality detection program are not limited to being stored in the hard disk drive 1031, and may be stored in, for example, a removable storage medium and read by the CPU 1020 via the disk drive 1041 or the like. Alternatively, the program module 1093 and the program data 1094 related to the abnormality detection program may be stored in another computer connected via a network such as a LAN or a wide area network (WAN) and read by the CPU 1020 via the network interface 1070.

Although the embodiment to which the invention made by the present inventor is applied has been described above, the present invention is not limited by the description and drawings constituting a part of the disclosure of the present invention according to the present embodiment. That is, other embodiments, examples, operation techniques, and the like made by those skilled in the art based on the present embodiment are all included in the scope of the present invention.

### REFERENCE SIGNS LIST

10 Abnormality detection device
11 Input unit
12 Output unit
13 Communication control unit
14 Storage unit
14a Buffer region
14b Calculation result
15 Control unit
15a Acquisition unit
15b Calculation unit
15c Analysis unit

1. An abnormality detection device comprising:
an acquisition unit, comprising one or more processors, configured to acquire past traffic data and store the past traffic data in a buffer region of a storage unit;
a calculation unit, comprising one or more processors, configured to calculate an average and a variance of traffic data in the buffer region by applying the traffic data to a predetermined recurrence formula; and
an analysis unit, comprising one or more processors, configured to calculate a Z score representing a deviation from an average of traffic data as a processing target by using the average and the variance that have been calculated, and analyze whether the traffic data is abnormal by using the Z score.

2. The abnormality detection device according to claim 1, wherein,
when calculating an average and a variance of traffic data acquired next, the calculation unit is configured to further use the average and the variance further calculated.

3. The abnormality detection device according to claim 1, wherein
the calculation unit is configured to apply past traffic data to the recurrence formula that has been weighted such that a contribution degree of traffic data is smaller as the traffic data is further past data.

4. The abnormality detection device according to claim 1, wherein
the analysis unit is configured to determine that the traffic data as the processing target is abnormal when the Z score that has been calculated is larger than a predetermined threshold.

5. An abnormality detection method performed by an abnormality detection device,
the abnormality detection device including a storage unit,
the abnormality detection method comprising:
acquiring past traffic data and storing the past traffic data in a buffer region of the storage unit;
calculating an average and a variance of traffic data in the buffer region by applying the traffic data to a predetermined recurrence formula; and
calculating a Z score representing a deviation from an average of traffic data as a processing target by using the average and the variance that have been calculated, and analyzing whether the traffic data is abnormal by using the Z score.

6. A non-transitory computer readable medium storing a program, wherein execution of the program causes a computer to execute operations comprising:
acquiring past traffic data and storing the past traffic data in a buffer region of a storage unit;
calculating an average and a variance of traffic data in the buffer region by applying the traffic data to a predetermined recurrence formula; and
calculating a Z score representing a deviation from an average of traffic data as a processing target by using the average and the variance that have been calculated, and analyzing whether the traffic data is abnormal by using the Z score.
